(19) United States
(12) Patent Application Publication
(10) Pub. No.: US 2004/0196741 A1
(43) Pub. Date: Oct. 7, 2004

(54) Pendulum system for producing light and power

(76) Inventor: Christian Durr, Cincinnati, OH (US)

Correspondence Address: MELVIN K. SILVERMAN, 500 WEST CYPRESS CREEK ROAD, SUITE 500, FT. LAUDERDALE, FL, 33309, US

(21) Appl. No.: 10/814,936

(22) Filed: Mar. 30, 2004

Related U.S. Application Data
(60) Provisional application No. 60/459,042, filed on Apr. 1, 2003.

(51) Int. Cl. G04B 47/00

(52) U.S. Cl. 368/91

(57) ABSTRACT

An energy source forming a gravity pendulum clock, including a train of clock gears, includes a fixed position generator having its axle of rotation secured to an axle of rotation of at least one gear of the chain of clock gears; output leads from the generator, the leads comprising an input to a device to be powered; a fixed position solenoid in magnetic communication with a ferromagnetic element; and output leads from the solenoid, the leads defining an input to the device to be powered.

### REFERENCE TO RELATED APPLICATION

This application claims the benefit under 35 USC 119 (e) of the provisional patent application Serial No. 60/459,042, filed Apr. 1, 2003, which is herein incorporated by reference in its entirety.

### BACKGROUND OF THE INVENTION

The present invention is directed to a novel use of pendulum type device, such as a pendulum clock, for the purpose of generating supplemental power and light, or LED related special effects.

The gravity powered pendulum clock has existed for many centuries, and a representative example thereof appears in U.S. Pat. No. 3,290,874 (1966) to Koplar, entitled Gravity Pendulum Clock Escapement.

Similar principles have been employed in other structures to power clock dials, chimes, moving signs, and the like, as is reflected in U.S. Pat. No. 4,455,094 (1,994) to Russell, entitled Motion Apparatus. The use of oscillatory motion, particularly wave motion, for the generation of electrical energy has been suggested in U.S. Pat. No. 4,260,901 (1981) to Woodbridge, entitled Wave Operated Electrical Generation System. The use of vibratory motion to produce electrical energy is suggested by U.S. Pat. No. 5,578,877 (1966) to Tiemann, entitled Apparatus for Converting Vibratory Motion to Electrical Energy. An apparatus for the conversion of linear motion to electrical energy is taught in U.S. Pat. No. 5,818,132 (1998) to Konopchick, entitled Linear Motion Electric Power Generator.

The present invention is directed to a means of utilizing angular and linear motion associated with a pendulum clock as a source of supplemental energy and to power for special lighting effects such as LEDs associated with the clock itself.

### SUMMARY OF THE INVENTION

The angular rotation associated with a gravity pendulum clock is employed as a potential source of electrical energy while linear motion associated therewith is captured to provide a further energy and light generating means.

It is an objective of the present invention to widen of the use of energy associated with the pulling of the chain of weighted elements associated with a gravity pendulum clock such that, as said weight drops, its movements, both angular and linear relative to the gears of the clock (often termed a cuckoo clock) will drive a small generator or solenoid to provide supplemental sources of electrical power and, therewith, power to a light emitting diode or other means associated therewith.

Its therefore another object to provide a system by which a gravity powered pendulum clock can provide a power source to nights lights, closet lights, gardens, tents and emergency lighting needs.

A yet further object of the invention to provide a system which may be used in combination with a wind turbine such that, in the absence of wind, supplemental power may be supplied to the turbine during what would otherwise constitute down time of the system.

It is another object to provide a system of the above type capable of charging rechargeable batteries and capacitors.

It is still further object to provide a system to which serve as a source of supplemental lighting for cabins not having power, and for emergency lighting therein.

It is still further object to provide a system of the above type to enhance the use of wind power into related areas such as the pumping of liquids.

Another object is to provide a system of the above type for integration into a transistor radio for the purposes of providing power thereto.

The above and yet other objects and advantages of the invention will become apparent from the herein after set forth Brief Description of the Drawings and Detailed Description of the Invention.

### BRIEF DESCRIPTION OF THE DRAWINGS

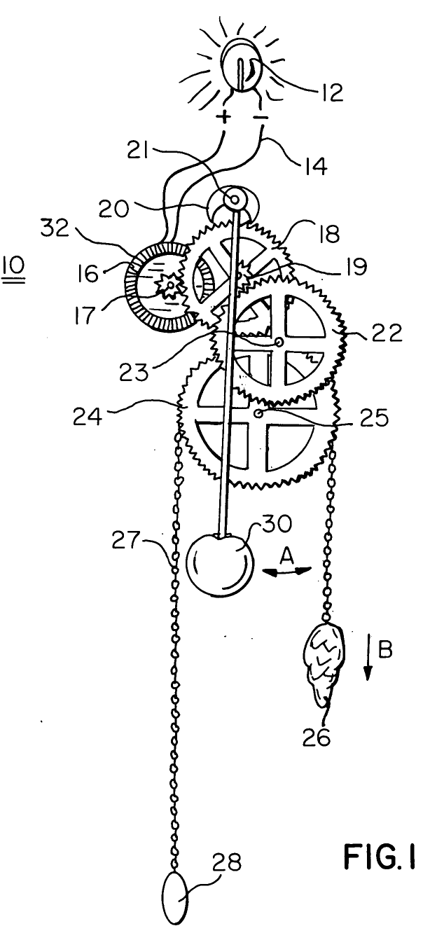

Shown in FIG. 1 is a front view of a clockwork or escapement of a basic gravity pendulum clock to which the present invention relates, showing a first embodiment of the invention.

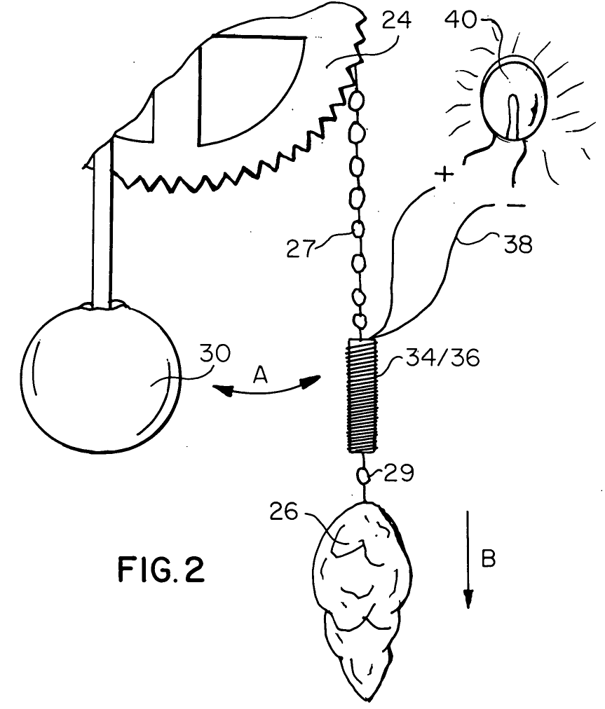

In FIG. 2 is shown a second embodiment thereof.

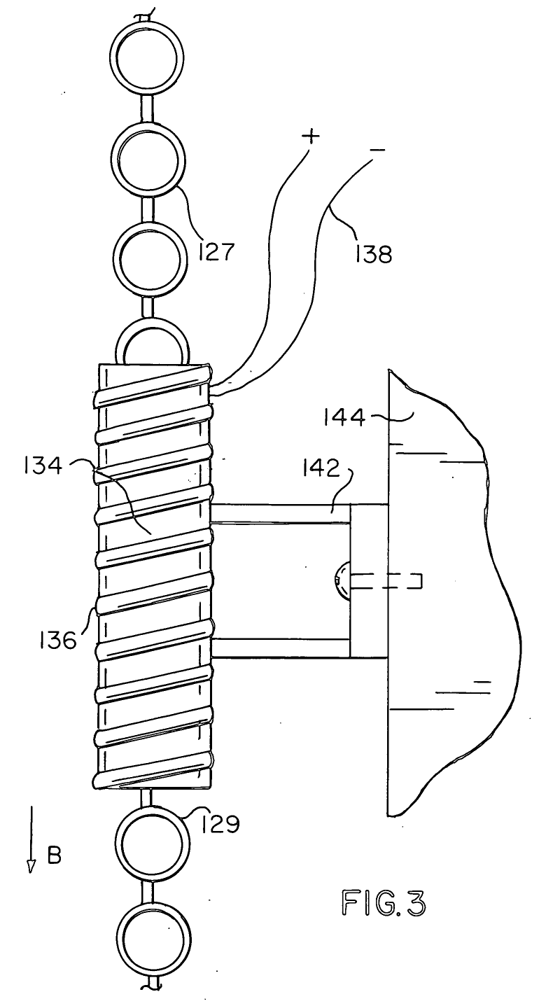

In FIG. 3 is shown a third embodiment of the inventive gravity operated electrical energy generating means.

### DETAILED DESCRIPTION OF THE INVENTION

In FIG. 1 is shown the essential mechanical elements of a gravity pendulum clock escapement, often termed a cuckoo clock 10.

Said clock includes a suitable train of clock gears including driving gear 24 which is mounted upon an axle 25; a driven gear 18 which is mounted upon axle and axle gear 19 which in turn drives gear 22 which is journalled upon axle 23. Said driven gear 18 also drives axle gear 17 and, thereby gear 16. Pendulum clock 10 is started by pulling chain 23 and, with it, associated weight 26. This will cause the clockwise rotation of said gear 24 and the downward linear travel of weight 26. By pulling chain 27 downward, weight 26 is lifted such that the potential energy of gravity will power the above described gear train consisting of gears 16, 18, 22 and 24. More particularly, as weight 26 advances downward in Direction B, gear 25 will rotate gear 18 which in turn will rotate pendulum gear 20 and axle 21 of pendulum 30. Also gear 28 will cause the counter clockwise rotation of turbine 16 which is a part of an electrical generator. That is, windings 32 of such generator that will generate electricity and transmit the same to an element 12 which may comprise either a battery or a light such as an LED.

In FIG. 2 is shown a further embodiment of the invention in which the part of chain 27 to which weight 26 is attached is provided with a ferromagnetic core 34 which is connected to a weight 26 by means 29. A helical winding 36 is permitted to slide linearly, upwardly and downwardly relative to core 34 such that small amount of electricity are generated as the wires of coil 36 break the lines of magnetic flux of the magnetic core 34. Electricity so generated is carried by wires 38 to a battery or light source 40 which may be employed for any of the above set forth purposes of the present invention.

A further embodiment of the invention is shown in FIG. 3. Therein magnetic core 134 is held stationery relative to chains 127 and 129 while coil 136 is secured by means 142 to a wall 144. Thereby, as weight 26 advances downward in Direction B lines electromagnetic flux of core 134 will be broken by stationery coil 136 and, thereby, electricity provided through wires 138 to a light battery, or other external device as set forth above.

In summary, the incremental angular reciprocation of pendulum 30 caused, by the gear action of the clock escapement, is transmitted to the windings of turbine 16 and, thereby, thru wires 14 to external energy or light source 12, while the linear motion associated with a progressive downward travel of weight 26 is converted into electrical energy through one of the solenoid-type arrangements set forth in FIGS. 2 and 3 above. Thereby, the objects of the invention relative to the various uses and applications set forth in the objects of the invention above may be readily achieved without significant increase in the complexity of an otherwise conventional gravity pendulum clock.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth herewith.

1. An energy source, comprising:
(a) a gravity pendulum clock;
(b) ferromagnetic means secured to a vertically moving weighted chain of said clock;
(c) a fixed position solenoid in magnetic communication with said ferromagnetic means; and
(d) output leads from said solenoid, said leads comprising an input to a device to be powered.

2. An energy source, comprising:
(a) a gravity pendulum clock, including a train of clock gears;
(b) a fixed position generator having its axle of rotation secured to an axle of rotation of at least one gear of said chain of clock gears; and
(c) output leads from said generator, said leads comprising an input to a device to be powered.

3. The energy source as recited in claim 2, further comprising:
(d) a fixed position solenoid in magnetic communication with ferromagnetic means; and
(e) output leads from said solenoid, said leads comprising:
an input to a device to be powered.
